(19) United States
(12) Patent Application Publication
(10) Pub. No.: US 2006/0152591 A1
(43) Pub. Date: Jul. 13, 2006

(54) Automatic focus mechanism of an image capturing device

(76) Inventor: Sheng-feng Lin, Changhua County (TW)

Correspondence Address: THE MAXHAM FIRM, 750 "B" STREET, SUITE 3100, SAN DIEGO, CA, 92101, US

(21) Appl. No.: 11/035,491

(22) Filed: Jan. 13, 2005

(51) Int. Cl. H04N 5/228

(52) U.S. Cl. 348/208.12

(57) ABSTRACT

The present invention discloses an automatic focus mechanism of an image capturing device. The coil with current flowing therein of the image capturing device can be driven by the magnetic field created by a permanent magnet and a yoke, thereby driving focusing lens module through magnetic field interaction. In capturing image, the focusing lens module can focus an image on an image sensor.

### FIELD OF THE INVENTION

The present invention relates to an automatic focus mechanism of a camera, and more specially, to a magnetic force created by an interaction between magnetism material and wires with electrical current driving a lens module, thereby automatic focusing an image on an image sensor of the camera.

### DESCRIPTION OF RELATED ART

With substantially developing of mechanical automation and metering technique, it indicates adequately that photograph technique has entered an automation stage. The key factor of taking picture's rate depends on an automatic focus system, and the automatic focus system has become a developing index of camera manufacturers.

Nikon's corporation proposed a camera style with automatic focus in 1974. That design depends on extremely mechanical structure and its drawbacks are whole body larger and slow response. Moreover, Honeywell's corporation US developed a very practical automatic focus system, called VAF system. In VAF system, it is difficult and lack of accuracy for automatic focus.

Furthermore, proposed by Kyeongsangnam et al. U.S. Pat. No. 5,555,059 in 1994,2,14, it discloses an electromagnetic lens shutter apparatus that can be applied to a camera having an automatic exposure control function and an automatic focus control function. Besides, proposed by Tokyo et al. U.S. Pat. No. 4,505,567 in 1983, 3,16, it discloses an electromagnetically driven shutter with focus adjusting function.

In view of the above-mentioned problem, it is an object of this invention to provide a new automatic focus mechanism of an image acquisition apparatus (such as camera).

### SUMMARY OF THE INVENTION

In view of the above-mentioned, it is an object of this invention to provide an automatic focus mechanism of an image acquisition apparatus (such as camera).

The other object of the present invention is to disclose an automatic focus mechanism of an image acquisition apparatus that is simple structure, easy to configure and low cost.

The yet another object of the present invention is to disclose an automatic focus mechanism of a digital camera that adapts a continuous displacement focusing.

The further object of the present invention is to disclose an automatic focus mechanism of a digital camera that adapts miniaturization to save accumulation space.

The present invention discloses an automatic focus mechanism of a camera, comprising:

an upper base;

an U-shape yoke fixed on the upper base;

a permanent magnet configured between the U-shape yoke and fixed on the upper base, between the U-shape yoke and the permanent magnet having a first magnetic field distribution formed therein;

a lower base;

guiding stick fixed on the upper base or the lower base;

a loading holder having a first hollow space for disposing the U-shape yoke and the permanent magnet, wherein the loading holder is utilized for loading a lens module and configured above the lower base;

a wire bobbin having a second hollow space for disposing the permanent magnet and having wires winded on the wire bobbin, wherein the wire tray is configured between the U-shape yoke and fixed on the loading holder; and

an image sensor configured under the loading holder and mounted in the lower base;

wherein a magnetic force created by an interaction between the first magnetic field distribution and a second magnetic field distribution formed by the wires with electrical current drives the lens module on the loading holder, thereby focusing on the image sensor.

The present invention further comprises an elastic member configured on the loading holder for providing a restoring force along basis axis of the guiding stick, wherein the elastic member is helical spring surrounded the guiding stick.

In a preferred embodiment, the camera comprises single-lens reflex camera or compound-lens reflex camera. In a preferred embodiment, lens module is lens module with filtering, blurring effect.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates an automatic focus mechanism of an image acquisition apparatus according to the present invention.

FIG. 2 illustrates a three-dimensional drawing of an automatic focus mechanism of an image acquisition apparatus according to the present invention.

### DETAILED DESCRIPTION OF THE PREFERRED EMBODIMENTS

Referring now to the drawings and the following description wherein the showings and description are for the purpose of illustrating the preferred embodiments of the present invention only, and not for the purpose of limiting the same.

The present invention discloses an automatic focus mechanism of a camera. The mechanism comprises an upper base and a lower base. An U-shape yoke is fixed on the upper base. A permanent magnet is configured between the U-shape yoke and fixed on the upper base, and between the U-shape yoke and the permanent magnet has a first magnetic field distribution formed therein. A guiding stick is fixed on the upper base or the lower base. A loading holder has a first hollow space for disposing the U-shape yoke and the permanent magnet, wherein the loading holder is utilized for loading a lens module and configured above the lower base. A wire bobbin has a second hollow space for disposing the permanent magnet and has wires winded on the wire bobbin, wherein the wire bobbin is configured between the U-shape yoke and fixed on the loading holder. An image sensor is configured under the loading holder and mounted in the lower base. Wherein a magnetic force created by an interaction between the first magnetic field distribution and a second magnetic field distribution formed by the wires with electrical current drives the lens module on the loading holder, thereby adjusting the focus of the lens to be located on the image sensor.

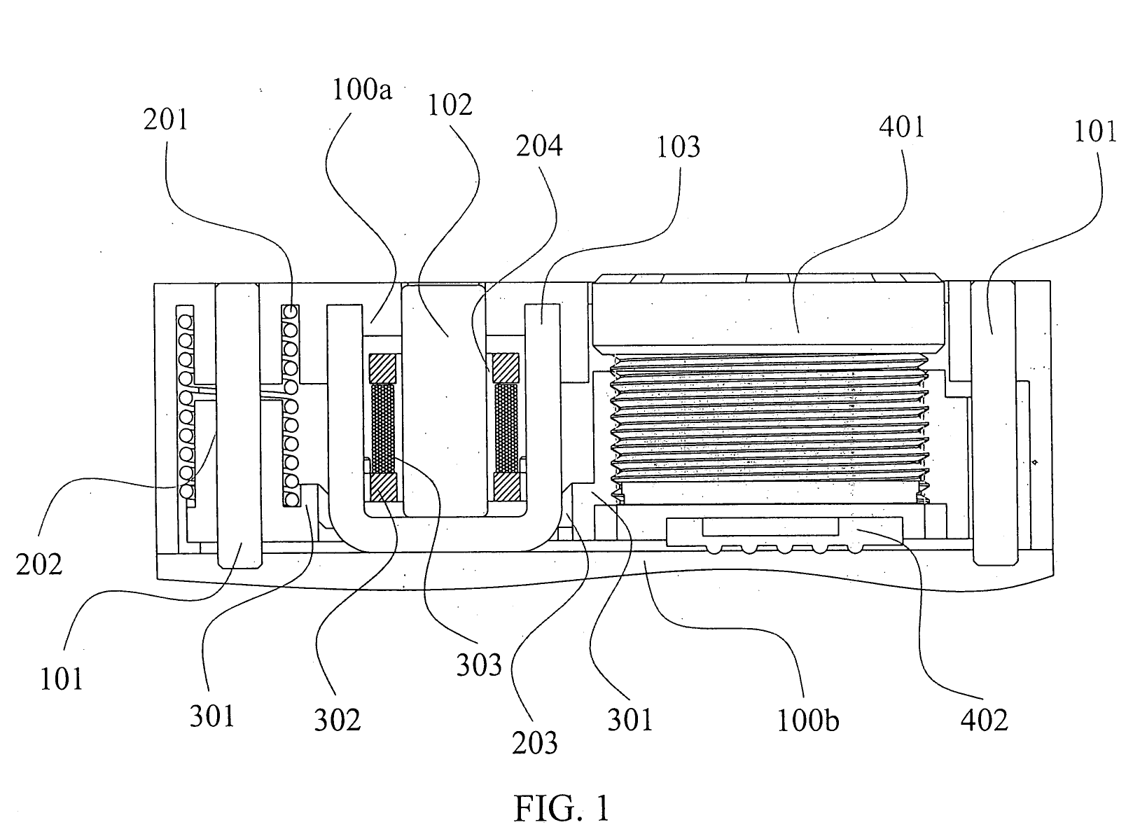

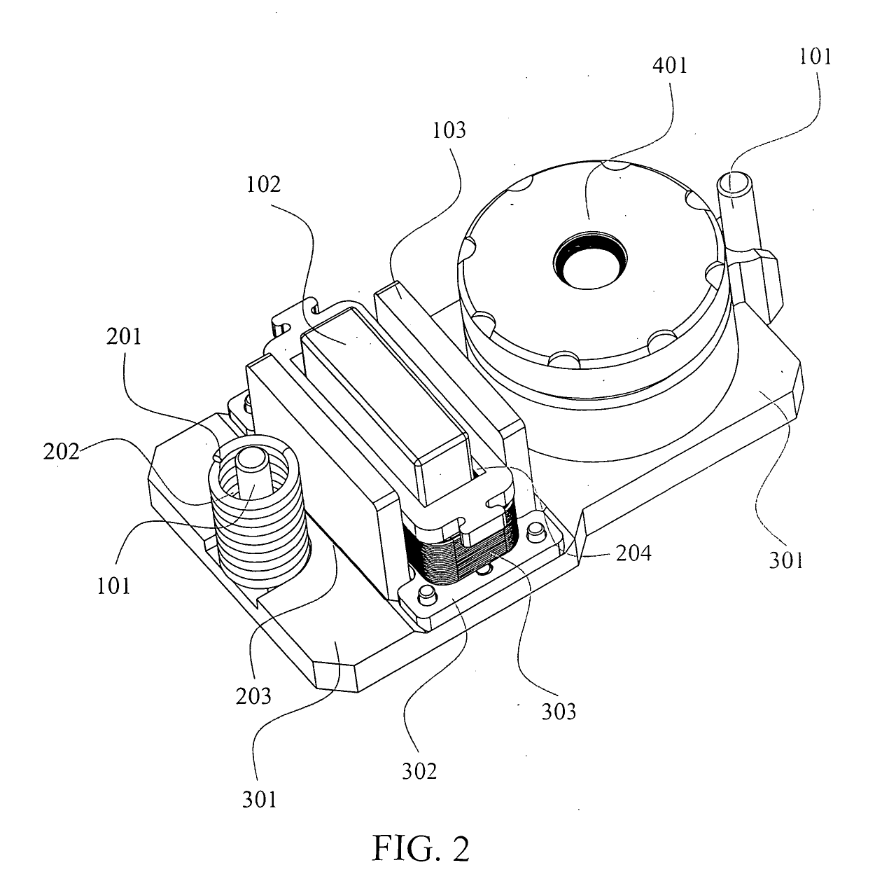

As shown in FIGS. 1 and 2, they are an automatic focus mechanism of an image capturing device according to the present invention. The image capturing device comprises but not limited a single-lens reflex camera or a compound-lens reflex camera. The automatic focus mechanism of an image capturing device comprises upper base 100a, lower base 100b, yoke 103, magnet 102, loading holder 301, wire tray 302 and image sensor 402. According to the present invention, the yoke 103 is fixed on the upper base 100a. In one embodiment, the yoke 103 comprises but not limited an U-shape yoke. Besides, the magnet 102 is configured between the U-shape yoke 103 and fixed on the upper base 100a so that between the U-shape yoke 103 and the magnet 102 has a specific magnetic field distribution formed therebetween. The specific magnetic field distribution is determined by the spacing between the U-shape yoke 103 and the magnet 102. In one embodiment, the magnet 102 comprises but not limited a permanent magnet.

The loading holder 301 has a first hollow space 203 for disposing the U-shape yoke 103 and the permanent magnet 102. The loading holder 301 is utilized for loading a lens module 401 and configured above the lower base 100b. The wire bobbin 302 has a second hollow space 204 for disposing the permanent magnet 102, and the wire bobbin 302 has wires 303 winded on the wire bobbin 302. The wire bobbin 302 is configured between the U-shape yoke 103 and fixed on the loading holder 301. The wires 303 on the wire bobbin 302 may be created an electrical current by electrified, therefore the current orientation may be clockwise or counterclockwise owing to the wires 303 winded on the wire bobbin 302. According to physical principle, the wires 303 with electrical current will create another specific magnetic field distribution, and the magnitude of the magnetic field is proportion to amount of the electrical current.

Moreover, two guiding sticks 101 are fixed two sides on the upper base 100a or the lower base 100b through holes 202 of the loading holder 301. The guiding sticks 101 are provided a basis axis for moving the lens module 401. In one embodiment, the lens module 401 comprises but not limited a lens module with filtering or blurring effect.

In one embodiment, the wire bobbin 302 with the wires 303 is fixed on the loading holder 301, and the loading holder 301 is used to load the lens module 401, thereby constituting a driving mechanism of focusing lens module 401 of the present invention. Based on the U-shape yoke 103 and the permanent magnet 102 fixed on the upper base 100a, the specific magnetic field distribution between the U-shape yoke 103 and the permanent magnet 102 is utilized to drive the wires 303 with electrical current, thereby driving the lens module 401 on the loading holder 301 by magnetic force created by an interaction between two specific magnetic field distribution. The orientation of the magnetic force may be up or down depending on the current orientation of the wires 303 clockwise or counterclockwise. As the above-mentioned, the guiding sticks 101 can provided a basis axis for the lens module 401 moving, therefore the lens module 401 may move upwardly or downwardly to a desired position to allow the desired image may be focused on the image sensor 402. That is to say, during the image capturing procedure, the lens module 401 may be driven to make the desired image to be focused on the image sensor 402. In one embodiment, the image sensor 402 comprises but not limited a CMOS image sensor or a CCD image sensor. The image sensor 402 is configured under the loading holder 301 and mounted in the lower base 100b.

The image light may be projected on the image sensor 402 through the lens module 401 configured under the loading holder 301. The image sensor 402 may distinguish the image contents by light and shade of the image (that is contrast). When the image sensor 402 gets the same image contents in focusing process of a digital camera, automatic focusing is completed. That is, the movement of the lens module 401 reaches a correct focusing position. The lens module 401 may move a distance up or down in each image capturing procedure, therefore the present invention provides an elastic member 201 configured on the loading holder 301 for providing a restoring force along basis axis of the guiding sticks 101 in automatic focusing process. In one embodiment, the elastic member 201 comprises but not limited a helical spring surrounded the guiding stick 101.

From the foregoing, it is an object of this invention to provide an automatic focus mechanism of an image capturing device (such as camera). The advantages of the automatic focus mechanism of an image acquisition apparatus of the present invention comprises, 1) simple structure, easy to configure and low cost; 2) a continuous displacement focusing; 3) miniaturization to save accumulation space.

While the invention is described and illustrated here in the context of a limited number of embodiments, the invention may be embodied in many forms without departing from the spirit of the essential characteristics of the invention. The illustrated and described embodiments are therefore to be considered in all respects as illustrative and not restrictive. Thus, the scope of the invention is indicated by the appended claims rather than by the foregoing description, and all changes which come within the meaning and range of equivalency of the claims are intended to be embraced therein.

What is claimed is:

1. An automatic focus mechanism of an image capturing device, comprising:
an upper base;
a yoke fixed on said upper base;
a magnet configured between said yoke and fixed on said upper base, between said yoke and said magnet having a first magnetic field distribution formed therebetween;
a lower base;
a loading holder having a first hollow space for disposing said yoke and said magnet, wherein said loading holder is utilized for loading a lens module and configured above said lower base;
a wire bobbin having a second hollow space for disposing said magnet and having wires winded on said wire bobbin, wherein said wire bobbin is configured between said yoke and fixed on said loading holder; and
an image sensor configured under said loading holder and mounted in said lower base;
wherein a magnetic force created by an interaction between said first magnetic field distribution and a second magnetic field distribution formed by said wires with electrical current drives said lens module on said loading holder, thereby focusing an image on said image sensor.

2. The mechanism according to claim 1, further comprising a guiding stick fixed on said upper base or said lower base.

3. The mechanism according to claim 2, wherein the number of said guiding stick is two.

4. The mechanism according to claim 2, wherein said loading holder has a hole for disposing said guiding stick.

5. The mechanism according to claim 2, further comprising an elastic member configured on said loading holder for providing a restoring force along basis axis of said guiding stick.

6. The mechanism according to claim 5, wherein said elastic member is helical spring surrounded said guiding stick.

7. The mechanism according to claim 1, wherein said yoke is U-shape yoke.

8. The mechanism according to claim 1, wherein said magnet is permanent magnet.

9. The mechanism according to claim 1, wherein said image sensor is CMOS image sensor.

10. The mechanism according to claim 1, wherein said image sensor is CCD image sensor.

11. The mechanism according to claim 1, wherein said lens module is lens module with blurring effect.

12. The mechanism according to claim 1, wherein said lens module is lens module with filtering effect.

13. The mechanism according to claim 1, wherein said image capturing device is single-lens reflex camera.

14. The mechanism according to claim 1, wherein said image capturing device is compound-lens reflex camera.

15. An automatic focus mechanism of a camera, comprising:
an upper base;
an U-shape yoke fixed on said upper base;
a permanent magnet configured between said U-shape yoke and fixed on said upper base, between said U-shape yoke and said permanent magnet having a first magnetic field distribution formed therebetween;
a lower base;
guiding stick fixed on said upper base or said lower base;
a loading holder having a first hollow space for disposing said U-shape yoke and said permanent magnet, wherein said loading holder is utilized for loading a lens module and configured on said lower base;
a wire bobbin having a second hollow space for disposing said permanent magnet and having wires winded on said wire bobbin, wherein said wire bobbin is configured between said U-shape yoke and fixed on said loading holder; and
an image sensor configured under said loading holder and mounted in said lower base;
wherein a magnetic force created by an interaction between said first magnetic field distribution and a second magnetic field distribution formed by said wires with electrical current drives said lens module on said loading holder, thereby focusing an image on said image sensor.

16. The mechanism according to claim 15, wherein the number of said guiding stick is two.

17. The mechanism according to claim 15, wherein said loading holder has a hole for disposing said guiding stick.

18. The mechanism according to claim 15, further comprising an elastic member configured on said loading holder for providing a restoring force along basis axis of said guiding stick.

19. The mechanism according to claim 18, wherein said elastic member is helical spring surrounded said guiding stick.

20. The mechanism according to claim 15, wherein said image sensor is CMOS image sensor.

21. The mechanism according to claim 15, wherein said image sensor is CCD image sensor.

22. The mechanism according to claim 15, wherein said lens module is lens module with blurring effect.

23. The mechanism according to claim 15, wherein said lens module is lens module with filtering effect.

24. The mechanism according to claim 15, wherein said camera is single-lens reflex camera.

25. The mechanism according to claim 15, wherein said camera is compound-lens reflex camera.
